(19) United States
(12) Patent Application Publication
(10) Pub. No.: US 2026/0281772 A1
(43) Pub. Date: Sep. 17, 2026

(54) DEVICES, METHODS AND APPARATUSES FOR IMPROVING CHANNEL STATE INFORMATION MEASUREMENT AND REPORTING

(71) Applicant: Nokia Technologies Oy, Espoo (FI)

(72) Inventors: Matha DEGHEL, Massy (FR); Naizheng ZHENG, Beijing (CN)

(21) Appl. No.: 19/167,620

(22) PCT Filed: Apr. 4, 2023
(86) PCT No.: PCT/CN2023/086311

§ 371 Date: Sep. 22, 2025

(51) Int. Cl. H04W 24/10; H04B 7/08; H04L 5/00; H04W 72/044; H04W 72/231

(52) U.S. Cl. CPC H04W 24/10; H04B 7/088; H04L 5/0094; H04L 5/0096; H04W 72/046; H04W 72/231

(57) ABSTRACT

Exemplary embodiments of the present disclosure relate to improvement of channel state information (CSI) reporting. The terminal device receives information indicative of at least two spatial settings configured at the network device, wherein the information is to be used by the terminal device for at least one of following associated with a single CSI report configuration: channel state information (CSI) measurement, or CSI reporting. The terminal device performs, based on the information, one or more measurements associated with at least one spatial setting of the at least two spatial settings. The terminal device transmits at least one CSI report related to the one or more measurements. The CSI reporting as provided in the present disclosure may support dynamic spatial adaptation.

### FIELD

Exemplary embodiments of the present disclosure generally relate to the field of telecommunication, and in particular, to a terminal device, a network device, methods and apparatuses for improving channel state information (CSI) measurement and/or reporting.

### BACKGROUND

Network energy saving is of great importance for environmental sustainability, to reduce environmental impact (greenhouse gas emissions), and for operational cost savings. As 5G network is becoming denser, more antennas, larger bandwidths and more frequency bands are required. The environmental impact of 5G needs to stay under control, and novel solutions to improve network energy savings need to be developed.

Energy consumption has become a key part of the operating expense of the operators. Most of the energy consumption comes from the radio access network and in particular from the Active Antenna Unit (AAU), with data centers and fiber transport accounting for a smaller share. Dynamic spatial adaptation at a network device is being specified in network energy saving item of Rel-18 NR. Therefore, there is a need for improvement for CSI-reference signal (RS) measurement and reporting for dynamic spatial adaptation.

### SUMMARY

In general, exemplary embodiments of the present disclosure provide a solution for improving channel state information (CSI) measurement and/or reporting.

In a first aspect, there is provided a terminal device. The terminal device may comprise: at least one processor and at least one memory storing instructions that, when executed by the at least one processor, cause the terminal device at least to: receive, from a network device, information indicative of at least two spatial settings configured at the network device, wherein the information is to be used by the terminal device for at least one of following associated with a single CSI report configuration: channel state information (CSI) measurement, or CSI reporting; perform, based on the information, one or more measurements associated with at least one spatial setting of the at least two spatial settings; and transmit, based on the information, to the network device, at least one CSI report related to the one or more measurements.

In a second aspect, there is provided a network device. The network device may comprise: at least one processor and at least one memory storing instructions that, when executed by the at least one processor, cause the network device at least to: transmit, to a terminal device, information indicative of at least two spatial settings configured at the network device, wherein the information is to be used by the terminal device for at least one of following associated with a single CSI report configuration: channel state information (CSI) measurement, or CSI reporting; and receive, from the terminal device, at least one CSI report related to one or more measurements, wherein the one or more measurements are associated with at least one spatial setting of the at least two spatial settings and performed based on the information.

In a third aspect, there is provided a method. The method may comprise: receiving, by a terminal device and from a network device, information indicative of at least two spatial settings configured at the network device, wherein the information is to be used by the terminal device for at least one of following associated with a single CSI report configuration: channel state information (CSI) measurement, or CSI reporting; performing, by the terminal device and based on the information, one or more measurements associated with at least one spatial setting of the at least two spatial settings; and transmitting, by the terminal device and based on the information, to the network device, at least one CSI report related to the one or more measurements.

In a fourth aspect, there is provided a method. The method may comprise: transmitting, by a network device and to a terminal device, information indicative of at least two spatial settings configured at the network device, wherein the information is to be used by the terminal device for at least one of following associated with a single CSI report configuration: channel state information (CSI) measurement, or CSI reporting; and receiving, by the network device and from the terminal device, at least one CSI report related to one or more measurements, wherein the one or more measurements are associated with at least one spatial setting of the at least two spatial settings and performed based on the information.

In a fifth aspect, there is provided an apparatus. The apparatus may comprise: means for receiving, from a network device, information indicative of at least two spatial settings configured at the network device, wherein the information is to be used by the apparatus for at least one of following associated with a single CSI report configuration: channel state information (CSI) measurement, or CSI reporting; means for performing, based on the information, one or more measurements associated with at least one spatial setting of the at least two spatial settings; and means for transmitting, based on the information, to the network device, at least one CSI report related to the one or more measurements.

In a sixth aspect, there is provided an apparatus. The apparatus may comprise: means for transmitting, to a terminal device, information indicative of at least two spatial settings configured at the apparatus, wherein the information is to be used by the terminal device for at least one of following associated with a single CSI report configuration: channel state information (CSI) measurement, or CSI reporting associated with a single CSI report configuration; and means for receiving, from the terminal device, at least one CSI report related to one or more measurements, wherein the one or more measurements are associated with at least one spatial setting of the at least two spatial settings and performed based on the information.

In a seventh aspect, there is provided a non-transitory computer readable medium comprising program instructions that, when executed by an apparatus, cause the apparatus at least to: receive, from a network device, information indicative of at least two spatial settings configured at the network device, wherein the information is to be used by the apparatus for at least one of following associated with a single CSI report configuration: channel state information (CSI) measurement, or CSI reporting; perform, based on the information, one or more measurements associated with at least one spatial setting of the at least two spatial settings; and transmit, based on the information, to the network device, at least one CSI report related to the one or more measurements.

In an eighth aspect, there is provided a non-transitory computer readable medium comprising program instructions that, when executed by an apparatus, cause the apparatus at least to: transmit, to a terminal device, information indicative of at least two spatial settings configured at the apparatus, wherein the information is to be used by the terminal device for at least one of following associated with a single CSI report configuration: channel state information (CSI) measurement, or CSI reporting; and receive, from the terminal device, at least one CSI report related to one or more measurements, wherein the one or more measurements are associated with at least one spatial setting of the at least two spatial settings and performed based on the information.

In a ninth aspect, there is provided a computer program comprising instructions, which, when executed by an apparatus, cause the apparatus at least to: receive, from a network device, information indicative of at least two spatial settings configured at the network device, wherein the information is to be used by the apparatus for at least one of following associated with a single CSI report configuration: channel state information (CSI) measurement, or CSI reporting; perform, based on the information, one or more measurements associated with at least one spatial setting of the at least two spatial settings; and transmit, based on the information, to the network device, at least one CSI report related to the one or more measurements.

In a tenth aspect, there is provided a computer program comprising instructions, which, when executed by an apparatus, cause the apparatus at least to: transmit, to a terminal device, information indicative of at least two spatial settings configured at the apparatus, wherein the information is to be used by the terminal device for at least one of following associated with a single CSI report configuration: channel state information (CSI) measurement, or CSI reporting; and receive, from the terminal device, at least one CSI report related to one or more measurements, wherein the one or more measurements are associated with at least one spatial setting of the at least two spatial settings and performed based on the information.

In an eleventh aspect, there is provided a terminal device. The terminal device may include: a receiving circuitry for receiving, from a network device, information indicative of at least two spatial settings configured at the network device, wherein the information is to be used by the terminal device for at least one of following associated with a single CSI report configuration: channel state information (CSI) measurement, or CSI reporting; a performing circuitry for performing, based on the information, one or more measurements associated with at least one spatial setting of the at least two spatial settings; and a transmitting circuitry for transmitting based on the information, to the network device, at least one CSI report related to the one or more measurements.

In a twelfth aspect, there is provided a network device. The network device may include: a transmitting circuitry for transmitting, to a terminal device, information indicative of at least two spatial settings configured at the network device, wherein the information is to be used by the terminal device for at least one of following associated with a single CSI report configuration: channel state information (CSI) measurement, or CSI reporting; and a receiving circuitry for receiving, from the terminal device, at least one CSI report related to one or more measurements, wherein the one or more measurements are associated with at least one spatial setting of the at least two spatial settings and performed based on the information.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some exemplary embodiments will now be described with reference to the accompanying drawings, in which:

FIG. 1A illustrates an example of a network environment in which some embodiments of the present disclosure may be implemented;

FIG. 1B illustrates an example of configured different spatial patterns in accordance with some embodiments of the present disclosure;

FIG. 2 illustrates an exemplary signaling process for enabling flexible CSI measurement and/or reporting in accordance with some embodiments of the present disclosure;

FIG. 3 illustrates an exemplary signaling process for enabling several CSI reports associated with a single CSI report configuration in accordance with some embodiments of the present disclosure;

FIG. 4A illustrates an example of a sequence of spatial settings sequentially enabled in time in accordance with some embodiments of the present disclosure;

FIG. 4B illustrates an another example of a sequence of spatial settings sequentially enabled in time in accordance with some embodiments of the present disclosure;

FIG. 5A illustrates an example of a sequence repeated in time in accordance with some embodiments of the present disclosure;

FIG. 5B illustrates an another example of a sequence repeated in time in accordance with some embodiments of the present disclosure;

FIG. 6 illustrates a flowchart of an example method implemented at a terminal device in accordance with some embodiments of the present disclosure;

FIG. 7 illustrates a flowchart of an example method implemented at a network device in accordance with some embodiments of the present disclosure;

FIG. 8 illustrates a simplified block diagram of a device that is suitable for implementing some embodiments of the present disclosure; and

FIG. 9 illustrates a block diagram of an example of a computer-readable medium in accordance with some embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “includes”, “including”, “has”, “having”, “includes” and/or “including”, when used herein, specify the presence of stated features, elements, and/or components etc., but do not preclude the presence or addition of one or more other features, elements, components and/ or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Network energy saving is of great importance for environmental sustainability, to reduce environmental impact (greenhouse gas emissions), and for operational cost savings. As 5G is becoming pervasive across industries and geographical areas, handling more advanced services and applications requiring very high data rates (e.g. Extended Reality, XR). As networks are becoming denser, more antennas, larger bandwidths and more frequency bands are required. The environmental impact of 5G needs to stay under control, and novel solutions to improve network energy savings need to be developed. Energy consumption has become a key part of the operators' OPEX, the energy cost on mobile networks accounts for ~23% of the total operator cost. Most of the energy consumption comes from the radio access network and in particular from the Active Antenna Unit (AAU), with data centres and fibre transport accounting for a smaller share. The power consumption of a radio access may be split into two parts: the dynamic part which is only consumed when data transmission/reception is ongoing, and the static part which is consumed all the time to maintain the necessary operation of the radio access devices, even when data transmission/reception is not on-going.

In view of this, in Rel-18 NR, dynamic spatial adaptation is being specified for the purpose of network energy saving. Specifically, it specifies necessary enhancements on CSI and beam management related procedures including measurement and report, and signaling to enable efficient adaptation of spatial elements (e.g. antenna ports, active transceiver chains).

Generally speaking, when enabling efficient spatial (and power) adaptation procedure mentioned above, a plurality of spatial patterns and/or settings may be configured at the gNB. Consequently, spatial adaptation between multiple spatial patterns and/or settings at gNB may lead to multiple CSI reports. Conventionally, in order to achieve multiple CSI reports, multiple CSI reports configuration may be configured at gNB, that is to say, one CSI report configuration is configured at gNB for CSI report of one spatial pattern, thereby increase DL control overhead. Further, using multiple CSI report configurations to represent different spatial patterns/settings would not be feasible, as this would result in large number of CSI report configurations and this would then violate the legacy capabilities, for example, UE CSI/CSI-reference signal (RS) capabilities apply when considering total number of CSI reports and requirements.

According to embodiments of the present disclosure, there is provided a solution for improving CSI measurements and/or reporting for supporting dynamic spatial adaptation. In some example embodiments of the present disclosure, multiple spatial patterns may be evaluated or measured by triggering or activating the CSI report for a single CSI report configuration. That is to say, by configuring only a single CSI report configuration, multiple spatial patterns may be enabled or activated, and the flexible CSI reporting for the measurements of the multiple spatial settings may be achieved. Therefore, it may enable flexible multi-CSI measurement and/or reporting (as well as single measurement and/or CSI reporting), for evaluating/measuring various spatial settings/patterns for dynamic spatial adaptation, without increasing the DL control overhead, without need for additional CSI report configurations and further without increasing CSI processing units required/occupied by such measurements and reporting and further.

As for CSI Reference signals, the CSI-RS reference signals are UE-specifically configured in RRC. However, CSI-RS reference signals may be shared among many UEs, i.e., more than one UE are configured to receive the same resource elements (RE). CSI-RS has many functions in NR, e.g.: CSI-RS for DL CSI acquisition; CSI-RS for beam management (BM) (based on L1-RSRP); CSI-RS for tracking (TRS); and UL CSI acquisition in reciprocity-based UL precoding. In some applications (e.g., CSI-RS for BM), CSI-RS are spatially beam-formed into different directions.

In general, a UE may be configured with up to 48 report configurations per component carrier (CC)/4 per bandwidth part (BWP). One CSI-RS resource configured within one report configuration may be configured with up to 16 resource sets (aperiodic CSI) and 1 resource set (otherwise). In each CSI resource set up to 64 NZP CSI-RS resources and 1 NZP-CSI-RS resource up to 32 antenna ports. All CSI-RS resources within one set are configured with same density and same nrofPorts, except for the NZP CSI-RS resources used for interference measurement.

In the time domain, a CSI-RS resource may start at any OFDM symbol of a slot and it spans 1, 2, or 4 OFDM symbols depending on the number of ports configured.

For CSI acquisition or measurement, the UE is configured also with a codebook type. Given the measured channels across a CSI-RS resource, the UE may choose a favorite codeword from the specified codebook, i.e., precoding matrix indicator (PMI), along with channel quality indicator (CQI), rank indicator (RI). UE may also be configured to measure several CSI-RS resources (up to 8) within a resource set and report the favorite resource, CSI-RS resource indicator (CRI), along with PMI, CQI and RI which corresponds to that selected resource.

For CSI reporting, the UE measurement reporting of CSI may be also operated with periodic, semi-persistent, or aperiodic manner, which is so-called report types in NR report configuration. However, there are certain limitations, based on which the UE periodic report may operate only based on the configured periodic CSI-RS resource-set, the UE semi-persistent report may operate based on both configured periodic and semi-persistent CSI-RS resource-set, and finally the UE aperiodic report may operate based on all periodic, semi-persistent, and aperiodic CSI-RS resource-set. For example, the periodic CSI-RS resources may be used to generate any report type, the semi-persistent and periodic CSI-RS resources may be used to generate semi-persistent CSI reports, and the aperiodic CSI-RS may only be utilized only to generate the aperiodic report.

The CSI Report Setting also defines which part of the bandwidth the CSI should correspond to, and in addition, what granularity in frequency the CSI should have. To accomplish this, the bandwidth of a BWP is divided into a number of subbands. Based on this division of the BWP into subbands, the CSI reporting band for the CSI report is defined as an arbitrary subset of subbands of the BWP, which is indicated as a bitmap where each bit corresponds to one subband. The UE should only take the sub-bands in the CSI reporting band into account when determining the CSI.

The CSI Report Setting also defines the respective frequency-granularity of the PMI and CQI, which may be either wideband or subband. For wideband PMI/CQI, a single PMI/CQI corresponding the entire CSI reporting band is reported whereas for subband PMI/CQI, a separate PMI/CQI is reported for each constituent subband in the CSI reporting band. All CSI-RS resources within one set are configured with same density and same nrofPorts, except for the NZP CSI-RS resources used for interference measurement.

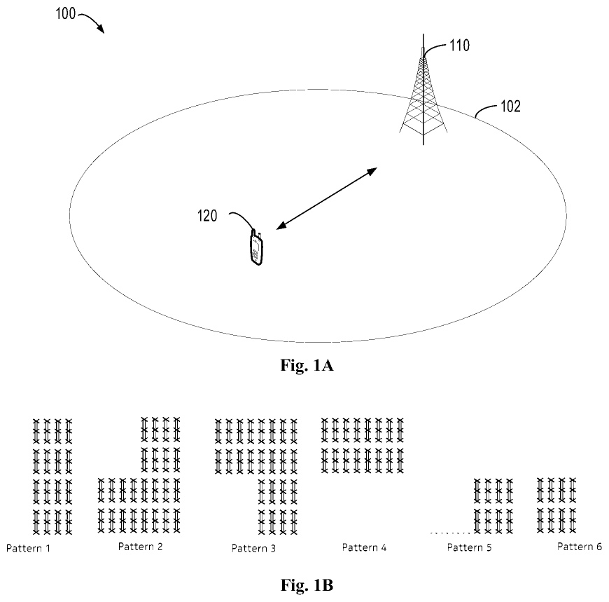

FIG. 1A illustrates an example of a network environment 100 in which some embodiments of the present disclosure may be implemented. In the descriptions of the exemplary embodiments of the present disclosure, the network environment 100 may also be referred to as a communication system 100 (for example, a portion of a communication network). For illustrative purposes only, various aspects of exemplary embodiments will be described in the context of one or more terminal devices and network devices that communicate with one another. It should be appreciated, however, that the description herein may be applicable to other types of apparatus or other similar apparatuses that are referenced using other terminology.

The network device 110 may provide services to the terminal device 120, and the network device 110 and the terminal device 120 may communicate data and control information with each other. In some embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1A, the network device 110 provides one serving cell 102, and the terminal device 120 camps on the serving cell 102. In some embodiments, the network device 110 may provide multiple serving cells. It is to be understood that the number of serving cell(s) shown in FIG. 1A is for illustrative purposes only without suggesting any limitation.

Communications in the network environment 100 may be implemented according to any proper communication protocol(s), including, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, including but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1A are for illustrative purposes only without suggesting any limitation. The communication system 100 may include any suitable number of devices adapted for implementing embodiments of the present disclosure.

As mentioned above, most of the energy consumption in 5G network comes from the radio access network and in particular from the Active Antenna Unit (AAU). The power consumption of a radio access may be split into two parts: the dynamic part which is only consumed when data transmission/reception is ongoing, and the static part which is consumed all the time to maintain the necessary operation of the radio access devices, even when the data transmission/reception is not on-going. In order to improve network energy saving, some antenna units may be muted by the access network device. Thus, in Rel-18 NR, dynamic spatial adaptation is being specified for the purpose of network energy saving. Dynamic spatial adaptation means that multiple spatial patterns/settings may be configured at gNB.

FIG. 1B illustrates some examples of different spatial patterns in accordance with some embodiments of the present disclosure. As shown in FIG. 1B, there are six different antenna patterns or spatial settings, for example, pattern 1, pattern 2, pattern 3, pattern 4, pattern 5, and pattern 6. In different antenna patterns, different antennas are muted or activated. The grey boxes are muted antennas or spatial elements, and the other antennas

### Are Not Muted Antennas or Spatial Elements.

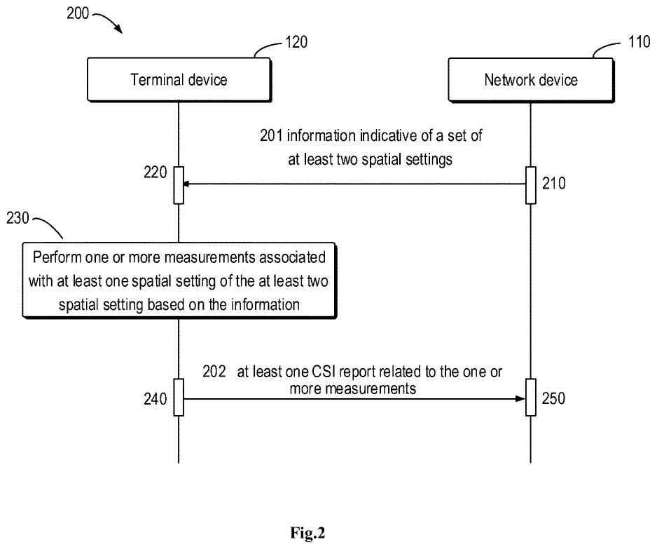

Hereinafter, an example signal process 200 for enabling multi-CSI or single-CSI measurement and/or reporting will be described with reference to FIG. 2. For the purpose of discussion, the process 200 may be described with reference to FIG. 1A. The process 200 may involve the terminal device 120 and network device 110 as illustrated in FIG. 1A. It would be appreciated that although the process 200 has been described in the communication environment 100 of FIG. 1A, this process may be likewise applied to other communication scenarios with similar issues.

As shown in FIG. 2, in process 200, the network device 110 transmits (210) information 201 to the terminal device 120. The information 201 is indicative of a set of at least two spatial settings configured at the network device 110, wherein the information is to be used by the terminal device 120 for channel state information (CSI) measurement and CSI reporting, which are associated with a single CSI report configuration. As shown in FIG. 2, the terminal device 120 receives (220) the information.

In one example, the set of at least two spatial settings may be configured to be a sequence of spatial settings. That is to say, in this sequence, there is a plurality of spatial settings configured by the terminal device 110. In one example, the set of at least two spatial settings may be configured to be a plurality of sequences of spatial settings, and some spatial settings included in different sequences of spatial settings may be the same, however, there is at least one spatial setting in a first sequence from those of a second sequence. That is to say, at least one sequence may be included in or be associated with a CSI report configuration (or more than one CSI report configuration). For example, at least one sequence (or list and/or order) of spatial settings or report sub-configurations may be associated to or included as part of the CSI report configuration via RRC (or MAC CE) or a triggering state or a resource setting. That is to say, for a CSI report configuration, it may include one sequence or more than one sequence.

The information 201 may then be used by the terminal device 120 to perform the CSI measurement and/or CSI reporting for a single CSI report configuration. That is to say, only a single CSI report configuration is configured at the network device 110, and by means of this CSI report configuration, it may enable flexible CSI measurement and/or CSI reporting. For example, enabling a report sub-configuration may imply or may correspond to enabling the corresponding at least one spatial setting. In the present disclosure, enabling the spatial setting may mean that the measurement(s) for this spatial setting may be performed by the terminal device 120. Accordingly, the information 201 includes effective data that may be used by the terminal device 120 to perform measurement. When performing the measurement, as shown in FIG. 2, the terminal device 120 performs (230), based on the information 201, one or more measurements associated with at least one spatial setting of the at least two spatial setting. At least one spatial setting selected from the at least two spatial settings are enabled, that is to say, the measurement for the at least one spatial setting is performed based on the information.

In the case of more than one sequence, the UE may be indicated via MAC CE or DCI which sequence is applicable, and a sequence may have an identifier. For example, one of the more than one sequence is first indicated by the information 201 to be applicable for the terminal device 120, and another one of the more than one sequence is then also indicated by the information 201 to be applicable for the terminal device 120, that is to say, the plurality of sequences may be applicable for the terminal device 120 sequentially in time.

For example, in the event that the set of spatial setting is configured to be a plurality of sequences, the spatial settings configured at the network device 110 may be indicated by the plurality of sequences, and the portion of the configured spatial settings to be enabled may be indicated via a DCI or a MAC CE transmitted to the terminal device 120 to be a sequence selected from the plurality of sequences. For example, if there are 8 configured spatial settings, they may be configured to be three sequences, in which, the first sequence includes spatial setting #1, spatial setting #2, spatial setting #3, and spatial setting #4; the second sequence includes spatial setting #3, spatial setting #4, spatial setting #5, and spatial setting #6; the third sequence includes spatial setting #5, spatial setting #6, spatial setting #7, and spatial setting #8. The portion of the configured spatial settings to be enabled may be indicated by the identifier of the first sequence, the second sequence or the third sequence.

In the case of a single sequence configured by gNB, the UE may be indicated (e.g., via DCI or MAC CE) whether this sequence should be applied or not, and if not, UE may be configured to use some default spatial setting or report sub-configuration, such as based on legacy reporting. Therefore, if a specific sequence, selected from the at least one sequence configured by the gNB or indicated by the gNB via the information 201, should be applied, this sequence may define one or more spatial settings for which the report sub-configurations are sequentially enabled in time.

For example, in the event that the set of spatial setting is configured in a sequence, the spatial settings configured at the network device 110 may be indicated by total bits of a bitmap, and the portion of the configured spatial settings to be enabled may be indicated by value “1” of bits in the bitmap. For example, if the number of total bits of the bitmap is 8, it may derive that 8 spatial settings are configured as a pool at the network device 110, and if the bitmap is [1 1 0 0 0 0 0 0], it means that only two of the 8 spatial settings are selected to be enabled/applicable and these two spatial setting may be measured.

As shown in FIG. 2, the terminal device 120 transmits (240) at least one CSI report 202 related to the one or more measurements to the network device 110. Then, the network device 110 receives (250) the at least one CSI report 202. In one embodiment, the number of the report may correspond to the number of the one or more measurements. However, in another embodiment, there is no need to perform CSI reporting for each of the one or more measurements, and one report may correspond to several CSI measurements, or correspond to the one having the best measurement value or having measurement value(s) satisfying certain criteria.

Therefore, in the process 200, the information 201 is used to split one CSI report configuration into several reporting sub-configurations, each of which corresponding to at least one spatial setting configured by the gNB, as described above, and two reporting sub-configurations may differentiate in at least the respective at least one spatial setting. That is to say, the information 201 includes related data that may be used to determine the one or more spatial setting for which the measurement will be performed, and then the terminal device 120 may perform measurement(s) for the one or more spatial settings.

In the process 200, the information 201 is not only used to indicate at least two spatial settings configured at the network device 110, but also used to trigger or activate one or more CSI measurements and/or one or more CSI reports associated with a single CSI report configuration. That is to say, by means of this single CSI report configuration, the pool of configured spatial settings and the number of the spatial setting(s) to be enabled or measured may both be indicated. That is to say, it may split one CSI report configuration into several reporting sub-configurations, each of which corresponding to at least one spatial setting configured by the gNB. The information associated with the single CSI report configuration may be flexibly configured such that it may enable flexible multi-CSI or single-CSI measurement and/or reporting for a single CSI report configuration, so as to enable efficient spatial (and power) adaptation procedure, such as antenna ports, or active transceiver chains. That is to say, it may enable flexible multi-CSI measurement and/or reporting as well as single CSI measurement and/or reporting, for evaluating/measuring various spatial settings/patterns, without increasing the DL control overhead and without the need for additional CSI report configurations in such a way to limit the CSI processing units required/occupied by such measurements and reporting.

In the following, the embodiments of how to indicate the enabled at least one spatial setting will be described.

In one example, DCI or MAC CE may indicate the sequence to be applicable by indicating a subset of a list of configured spatial settings or report sub-configurations which are configured via RRC or MAC CE, or by indicating a sequence from a list of sequences which are configured via RRC or MAC CE. The MAC CE or DCI mentioned above may be the one for triggering the CSI report(s) for the CSI report configuration or may be a separate one(s). Any of the above indications may be carried through new or existing/reserved bits/fields/entries.

The sequence of at least one spatial setting to be enabled is indicated by the information. The terminal device 120 may be provided with the information indicative the sequence of at least one spatial setting to be enabled, via downlink control information (DCI), medium access control element (MAC CE) or RRC message.

In some embodiments, the information 201 includes a bitmap or bit-string indicating a sequence of at least one spatial setting selected from a set of spatial settings configured by a gNB to be enabled. That is to say, the sequence of at least one spatial setting to be enabled may be represented by a bit-string or a bitmap, and this may assume that a pool or a set of spatial settings is configured via RRC message.

For example, each value of the bit-string may indicate one or more spatial setting or report sub-configuration. For example, if 8 is the total number of configured spatial settings or sub-configurations, then bit-string [000 001 010 011] may indicate a sequence consisting of the first 4 settings or sub-configurations selected from the configured spatial settings pool.

For example, each bit of the bitmap may correspond to at least one spatial setting or report sub-configuration, and preferably each bit may correspond to one spatial setting or report sub-configuration. Each bit may indicate, based on that its value is ‘0’ or ‘1’,whether the corresponding spatial setting or report sub-configuration is included in the sequence or not. For example, if 8 is the total number of configured spatial settings or sub-configurations, then bitmap [1 1 1 1 0 0 0 0] may indicate a sequence consisting of the first 4 settings or sub-configurations selected from the configured spatial setting pool.

In some embodiments, the information may further include codepoints. A codepoint may be associated to or representing a sequence or a part of a sequence. A subset of spatial settings or report sub-configurations, selected from a pool of settings or sub-configurations configured via RRC by gNB, may be ‘activated’ via MAC CE. That is to say, in MAC CE, one or more spatial settings or report sub-configurations are associated to a codepoint, and then UE is indicated via e.g., DCI (or MAC CE) at least one codepoint, and the at least one codepoint is indicative of the sequence of spatial setting(s) to be enabled.

For example, UE may be indicated or updated with up to a certain number (e.g., 8) of ‘active’ spatial settings or report sub-configurations. UE may then be indicated with a sequence including spatial settings or report sub-configuration from the active ones, via DCI (or MAC CE). Alternatively, UE may be indicated or updated with up to a certain number (e.g., 4) of ‘active’ sequences; UE may then be indicated via DCI (or MAC CE) one sequence to be applicable.

Firstly, the above ‘active’ spatial settings or report sub-configurations may be associated, e.g. via MAC CE, to ‘codepoints’ where a codepoint may be associated to at least one spatial setting or report sub-configuration. UE may then be indicated via DCI at least one codepoint. The sequence to be applicable or enabled or activated is then indicated by the at least one codepoint.

For example, Codepoint #1 (000) corresponds to spatial setting #1; Codepoint #2 (001) corresponds to spatial setting #2; Codepoint #3 (010) corresponds to spatial setting #3, spatial setting #4; and Codepoint #4 (011) corresponds to spatial setting #5.

For each of above mentioned codepoint, there may be an indication, via RRC or MAC CE or DCI, indicating that two or more spatial settings or report sub-configurations are aggregated; see codepoint #3 above where spatial setting #3 spatial setting #4 are aggregated. In this example, two spatial settings are aggregated for each codepoint.

Then, a bit-string or bitmap may be used in order to indicate, e.g. via DCI (or MAC CE), a sequence to be enabled or applicable or activated selected formed from the set of ‘active’spatial settings or report sub-configurations.

For example, assuming the above up to 8 codepoints, indication of bit-string [000 001 010] may correspond to the sequence {spatial setting #1, spatial setting #2, (spatial setting #3, spatial setting #4)}. Indication of bitmap [1 1 1 0 0 0 0 0] may correspond to the sequence {spatial setting #1, spatial setting #2, (spatial setting #3, spatial setting #4)}, where each bit corresponds to a codepoint (e.g., starting from the left-hand side of the bitmap and lowest codepoint index) e.g., bit value ‘1’ indicate that the corresponding codepoint is part of the sequence.

A mapping or association may be configured via RRC (or MAC CE) between a set of spatial settings (or report sub-configurations) and some MAC CE or DCI indicators (or fields). Based on an indication in MAC CE or DCI, the UE may know which sequence, or specifically spatial patterns, is/are applicable.

Hereinafter, the order of at least one spatial setting to be enabled and selected from the pool of configured spatial settings will be described.

In some embodiments, the order of the at least one spatial setting is determined by the terminal device based on the bitmap, bit-string, or codepoint included in the information 201. That is to say, the order of enabling the spatial settings or report sub-configurations in time may be taken from left to right (or right to left) of the bits in the bitmap or bit-string or codepoint included in the information 201. Alternatively, the order may be considering most/least significant bits first.

For example, the order of the selected setting #1, #2, #3 and #4 may be determined from left to right or from right to left of the bitmap [1 1 1 1 0 0 0 0 0] or bit string [000 001 010 011], when there is no codepoint associated with one or more spatial settings. In the case that there is codepoint associated with one or more spatial settings, for example, above mentioned codepoints #1, #2, #3, and #4, and then codepoints #1, #2, and #3 are indicated by DCI or MAC CE correspond to the sequence to be enabled, the order of the selected setting #1, #2, #3 and #4 may be determined from the left to right or from right to left of the bitmap [1 1 1 0 0 0 0 0 0] or bit string [000 001 010]. However, it should be noted that the codepoints may be indicated by other form, rather than the bitmap or bits string.

In some embodiments, an order of the selected at least one spatial setting is determined by the terminal device based on at least one rule included in the information. That is to say, the UE may also be provided with a rule to form the sequence. Specifically, the UE may be provided with a list of spatial patterns and UE may rely on an indication or rule to form the sequence. For example, the rule may be following descending/ascending order of the indexes of these spatial settings or corresponding sub-report configurations.

In some embodiments, the terminal device 120 may be provided with an order to form the sequence of spatial setting to be enabled. That is to say, the order may be included in the information.

It should be noted that, in some embodiments, the UE may further be provided with indication indicative, for each of at least one spatial setting or sub-reporting configuration, of the time duration during which this spatial setting or sub-reporting configuration is enabled. For semi-persistent or periodic reporting, the duration may be (based on) the periodicity of the CSI reporting or an integer number (which may be configured indicated to the UE) of this periodicity or a fraction of this periodicity. Alternatively, or additionally, the duration may be (based on) the periodicity of the CSI-reference signal (RS) or an integer number (which may be configured indicated to the UE) of this periodicity or a fraction of this periodicity. Any of the above time durations (or offsets) may be configured/indicated (via DCI, MAC CE, and RRC) to the UE.

Hereinafter, the embodiments of the time point, at which each spatial setting in the sequence is enabled or activated, will be descried.

For the first one of the spatial settings in the ordered sequence, this first spatial setting is to become applicable or active by the UE a period of time (or time offset) after receiving the PDCCH/PDSCH including the triggering of the report (sub)configuration(s) according to the sequence-such as after receiving CSI-RS timing offset.

For the spatial setting in the ordered sequence, except the first spatial setting, may be considered to become applicable or active by the UE: immediately after the UL CSI report corresponding to the previous spatial setting (if the spatial setting is the 2^{nd} one, the previous spatial setting is the 1^{st} one, and if the spatial setting is the 3^{rd} one, the previous spatial setting is the 2^{nd} one); after the UL CSI report corresponding to the previous spatial setting by a period of time (or time offset); before the first CSI-RS resource (for example, the CSI-RS resource for the second spatial setting in the sequence) among the CSI-RS resources for the spatial settings other than the first spatial setting occurs; when the first CSI-RS resource occurs; or within a time period or based on a time offset indicated to the terminal device.

It should be noted that when at least one spatial setting or report sub-configuration is enabled by UE, the other report settings or report sub-configurations in the sequence may be assumed by the UE to be disabled.

Hereinafter, the alternatives of the spatial setting or report sub-configuration will be described.

For example, a spatial setting or report sub-configuration may include or correspond to or be replaced by one or more of the following: at least one set/subset or number of (logical) antenna ports; at least one spatial configuration or codebook configuration (including codebook subset restriction, rank restriction, etc.); information indicative of set/subset or number of active (or muted) transceiver units or antenna elements or panels; at least one energy/power level or at least one energy saving level or at least one power offset; at least one frequency related configuration, such as sub-band configuration; at least one CSI-RS resource for channel or interference measurement(s); at least one CSI-RS resource set for channel or interference measurement(s); at least one spatial/antenna pattern; and at least one resource setting (covering resources for both channel and interference measurements).

Hereinafter, for each enabled one of at least one spatial setting or report sub-configuration included in the sequence, operations performed by the UE will be described. For each enabled spatial setting, the UE may perform at least one of the following: measure or derive corresponding CSI; select one or more of the at least one spatial setting; and/or report one or more of the at least one spatial setting, along with corresponding measurements (such as precoding matrix indicator (PMI), rank indicator (RI), channel quality indicator (CQI), L1-Reference Signal Receiving Power (RSRP), L1-Signal to Interference plus Noise Ratio (SINR), etc.), in a corresponding or a separate/dedicated UL (PUSCH/PUCCH) occasion.

That is to say, the UE may select part of the at least one spatial setting in the sequence to be reported, and then report the measurements for the selected spatial settings along with the selected spatial settings. For example, if the spatial setting #1, the spatial setting #2, and spatial setting #3 are included in the sequence, the UE may select the spatial settings with ‘good’ CSI measurements for reporting, for example, the spatial setting #2, and spatial setting #3 with measurement result above a threshold, and ignore the report for the spatial setting #1 with measurement result below the threshold.

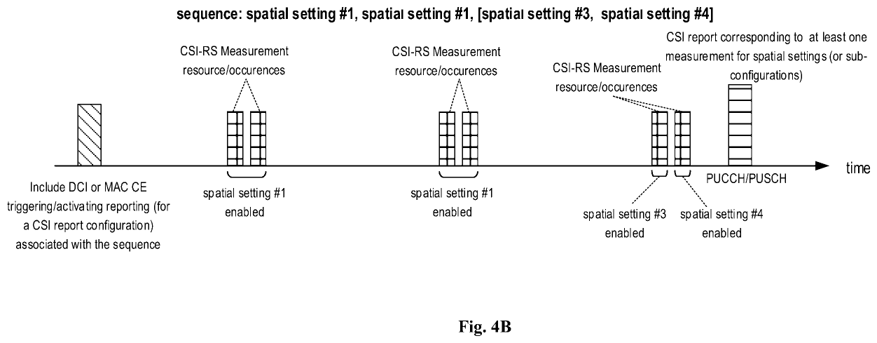

The last step of reporting the measurements for the spatial settings mentioned above will be described hereinafter, taking an example of a sequence of size three and semi-persistent or periodic report (which e.g. has periodic UL (PUCCH/PUSCH) occasions) into consideration: [report corresponding to the 1st spatial setting or reporting sub-configuration is reported in the 1st UL (reporting) occasion], [report corresponding to the 2nd spatial setting or reporting sub-configuration is reported in the 2nd UL (reporting) occasion]; [report corresponding to the 3rd spatial setting or reporting sub-configuration is reported in the 3rd UL (reporting) occasion]; [report corresponding to the 1st spatial setting or reporting sub-configuration is reported in the 4th UL (reporting) occasion]; [report corresponding to the 2nd spatial setting or reporting sub-configuration is reported in the 5th UL (reporting) occasion]; [report corresponding to the 3rd spatial setting or reporting sub-configuration is reported in the 6th UL (reporting) occasion], and so on. As may be noticed above, the UE would repeat this sequence in time, at least in case of periodic or semi-persistent CSI reporting, and follow the above defined behavior. That is to say, the entire sequence may be repeated in time, which will be described with referent to FIG. 5A in details hereinafter.

Hereinafter, the embodiments for repeating the spatial setting or report sub-configuration in another way, for example, in back to back manner will be described.

In some embodiments, a same spatial setting or report sub-configuration of at least one report setting or report sub-configuration may be repeated a number of times, e.g., in back-to-back fashion, in the sequence. This number may be indicated or configured, via RRC, MAC CE, and/or DCI, for the UE.

For example, in the sequence, the spatial setting #1, the spatial setting #2, and spatial setting #3 are included, and the settings repeated in back-to-back fashion may be repeated as follows: the spatial setting #1, the spatial setting #1; the spatial setting #2, the spatial setting #2; and the spatial setting #3, the spatial setting #3. The above mentioned example will be described with referent to FIG. 5B in details hereinafter.

For example, in the sequence, the spatial setting #1, the spatial setting #2, and [spatial setting #3, spatial setting 4], which are indicated by codepoints, are included, and the settings repeated in back-to-back fashion may be repeated as follows: the spatial setting #1, the spatial setting #1; the spatial setting #2, the spatial setting #2; and [the spatial setting #3, the spatial setting #4], [the spatial setting #3, the spatial setting #4].

It should be noted that at least one value in the sequence may indicate ‘empty’ or ‘not a number’. The UE would not consider measurement and/or reporting for this value; for instance, this could be used to accommodate some transition time (for the gNB and/or at the UE) needed to switch from one spatial pattern to another spatial pattern. Alternatively, the UE may be configured to assume a default spatial setting or report sub-configuration to be enabled in this case. A default spatial setting or report sub-configuration may be configured or defined to one in the sequence, or a separate spatial setting or report sub-configuration may be defined as default one. For example, in the sequence, the spatial setting #1, the spatial setting #2, and spatial setting #3 are included, and the spatial setting #2 in the sequence may be configured to be empty, or be configured to be a default spatial setting. Then when performing measurement for the spatial settings in the sequence, the measurement for the spatial setting #2 may be skipped and CSI report for this spatial setting #2 may correspond to the report for a default spatial setting.

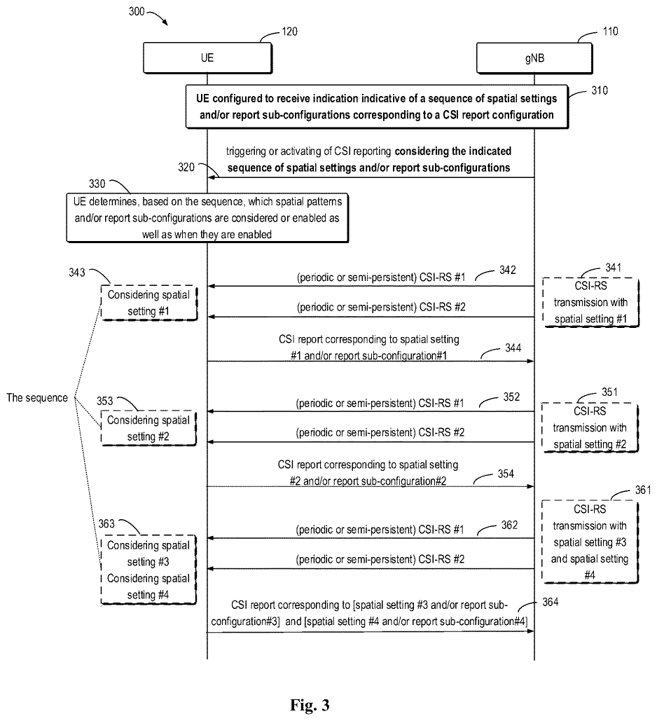

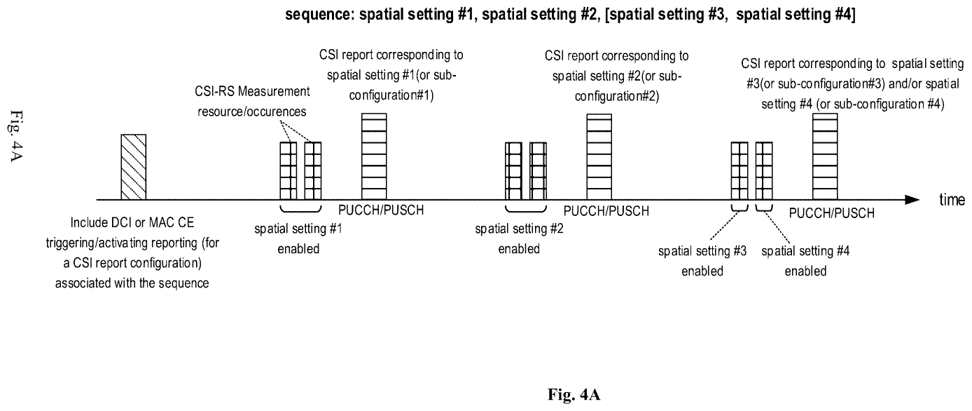

Hereinafter, the embodiments for enabling flexible multi-CSI measurement and/or reporting for this CSI report configuration with the above mentioned sequence indicated by bit-string [000 001 010] or bit map [1 1 1 0 0 0 0 0] will be described with reference to FIG. 3 and FIG. 4A. FIG. 3 illustrates an exemplary signaling process for enabling several CSI reports associated with a single CSI report configuration in accordance with some embodiments of the present disclosure; and FIG. 4A illustrates an example of a sequence of spatial settings sequentially enabled in time in accordance with some embodiments of the present disclosure.

As shown in FIG. 3, at step 310, the UE 120 is configured to receive indication indicative of a sequence of spatial settings and/or report sub-configurations corresponding to a CSI report configuration. As shown in FIG. 3, at step 320, the gNB 110 transmits a downlink control message (for example, DCI, or MAC CE) for triggering or activating of CSI reporting considering the indicated sequence of spatial settings and/or report sub-configurations. As shown in FIG. 4A, the first column on the time axis represents the DCI or MAC CE for triggering or activating reporting for a CSI report configuration associated with the sequence indicated at step 310. As shown in FIG. 3, at step 330, the UE 120 determines, based on the sequence, which spatial patterns and/or report sub-configurations are considered or enabled as well as when they are enabled, that is to say, the spatial settings included in the sequence may be ordered first based on a rule or any information about the indicated sequence, then they will be enabled sequentially in time.

As shown in FIG. 3, the sequence includes spatial setting #1, spatial setting #2, and [spatial setting #3 and spatial setting #4], and they will be enabled sequentially in time, as shown in steps 343, 353 and 363. For example, in the case of semi-persistent (or periodic) CSI-RSs, there may be configured a CSI-RS resource set including e.g. two resources which are time multiplexed. These would then correspond to two CSI-RS resources. Then these two CSI-RS resources are repeated in time given the periodicity of the semi-persistent (or periodic) CSI-RS. However, as another example, there may also be only one resource that is repeating in time, for the semi-persistent (or periodic) CSI-RSs. It should be understood by the person skilled in the art that the number of CSI-RS resources, the number of CSI reports and the manner for reporting (such as, periodic, semi-persistent, or aperiodic) as shown in FIG. 3 is just for illustration, and the present disclosure is not limited thereto.

As shown in FIG. 3, at step 341, the gNB 110 configures CSI-RS transmission or resource with spatial setting #1, for example two CSI-RS resources #1 and #2. As shown in FIG. 3, at step 342, the gNB 110 transmits the CSI-RS resource #1 and CSI-RS resource #2 associated with the spatial setting #1 to the UE 120. As shown in FIG. 4A, after the first column for trigger or activating, there are two adjacent columns for representing the two CSI-RS resources #1 and #2 transmissions or occurrences. As mentioned above, the CSI-RS is configured to be associated to the periodic or semi-persistent CSI-RS reporting, and there may be thus two CSI-RS resources #1 and #2, as shown in FIG. 4A. As shown in FIG. 3, at step 343, the UE 120 considers or enables or activates the spatial setting #1 by performing measurement for this CSI-RS resource #1 and CSI-RS resource #2 with spatial setting #1. At step 344, the UE 120 transmits the CSI report corresponding to spatial setting #1 and/or report sub-configuration #1 to the gNB 110. As shown in FIG. 4A, the UE 120 transmits the CSI report to the gNB 110 via PUCCH or PUSCH.

In the same way, as shown in FIG. 3, at step 351, the gNB 110 configures CSI-RS transmission or resource with spatial setting #2, for example two CSI-RS resources #1 and #2. As shown in FIG. 3, at step 352, the gNB 110 transmits the CSI-RS resource #1 and CSI-RS resource #2 associated with the spatial setting #2 to the UE 120. As shown in FIG. 4A, after the column for UL CSI report for the spatial setting #1, there are two adjacent columns for representing the two CSI-RS resources #1 and #2 transmissions or occurrences. As shown in FIG. 3, at step 353, the UE 120 considers or enables or activates the spatial setting #2 by performing measurement for this CSI-RS resource #1 and CSI-RS resource #2 with spatial setting #2. At step 354, the UE 120 transmits the CSI report corresponding to spatial setting #2 and/or report sub-configuration #2 to the gNB 110. As shown in FIG. 4A, the UE 120 transmits the CSI report to the gNB 110 via PUCCH or PUSCH.

In the same way, as shown in FIG. 3, at step 361, the gNB 110 configures CSI-RS transmission or resource with spatial setting #3 and spatial setting #4, for example two CSI-RS resources #1 and #2. As shown in FIG. 3, at step 362, the gNB 110 transmits the CSI-RS resource #1 and CSI-RS resource #2 associated with the spatial setting #3 and spatial setting #4 to the UE 120. As shown in FIG. 4A, after the column for UL CSI report for the spatial setting #2, there are two adjacent columns for representing the two CSI-RS resources #1 and #2 transmissions or occurrences. As shown in FIG. 3, at step 363, the UE 120 considers or enables or activates the spatial setting #3 and spatial setting #4 by performing measurement for this CSI-RS resource #1 and CSI-RS resource #2 with spatial setting #3 and spatial setting #4. At step 364, the UE 120 transmits the CSI report corresponding to [spatial setting #3 and/or report sub-configuration #3] and [spatial setting #4 and/or report sub-configuration #4] to the gNB 110. As shown in FIG. 4A, the UE 120 transmits the CSI report for spatial setting #3 and setting #4 to the gNB 110 via PUCCH or PUSCH.

Although in the embodiment as shown in FIG. 4A, there is a CSI report for each setting after the CSI RS resource for this setting occurs, it should be noted that there is not necessary to have a CSI report for each setting. For example, in the embodiment as shown in FIG. 4B, the sequence may include spatial setting #1, spatial setting #1, and [spatial setting #3, spatial setting #4], and the CSI reporting is performed in semi-persistent or periodic manner. It should be understood by the person skilled in the art that the number of CSI-RS resources, the spatial settings included in the sequence, the number of CSI reports and the manner for reporting (such as, periodic, semi-persistent, or aperiodic) as shown in FIG. 4B is just for illustration, and the present disclosure is not limited thereto. As shown in FIG. 4B, the CSI report may occur after all CSI-RS resources for the sequence occur, and the CSI report may include a part of all measurements or all measurements for all CSI-RS resources. For example, only the measurement above a threshold may be reported.

Hereinafter, the embodiments for repeating the spatial setting or report sub-configuration will be described with reference to FIG. 5A and FIG. 5B. However, it should be noted the repeated sequences are just illustrative, and the present disclosure is not limited thereto. FIG. 5A illustrates an example of a sequence repeated in time in accordance with some embodiments of the present disclosure and FIG. 5B illustrates another example of a sequence repeated in time in accordance with some embodiments of the present disclosure.

As mentioned above, UE would repeat this sequence in time, at least in case of periodic or semi-persistent CSI reporting. As shown in FIG. 5A, the sequence includes the spatial setting #1, spatial setting #2, and [spatial setting #3, spatial setting #4] indicated by three codepoints. The sequence may be repeated entirely in time, and that is to say, the measurement and/or reporting for entire sequence will be repeated sequence by sequence.

As mentioned above, the same spatial setting may be repeated in the sequence. As shown in FIG. 5B, the sequence includes spatial setting #1, spatial setting #2 and spatial setting #3. The CSI-RS resource may occur for two times, and in time domain, the occurrence of the CSI-RS resource may adjacent to each other. That is to say, the CSI-RS resource occurrences and two CSI reports for spatial setting #1 may be adjacent to each other.

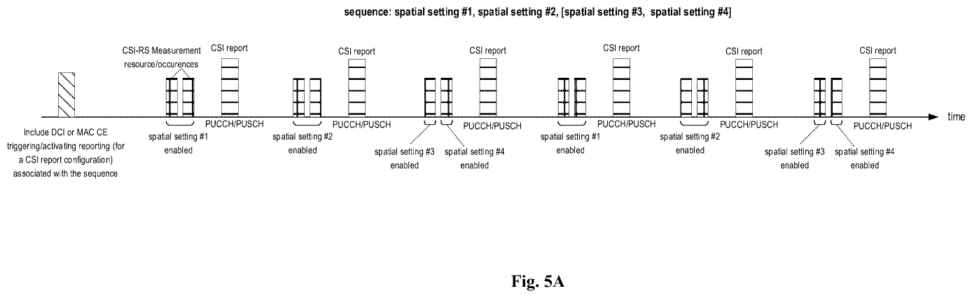

FIG. 6 illustrates a flowchart of an example method 600 implemented at a terminal device in accordance with some other embodiments of the present disclosure. For the purpose of discussion, the method 600 will be described from the perspective of the terminal device 120 with reference to FIG. 1A.

At block 610, the terminal device 120 receives, from a network device, information indicative of at least two spatial settings configured at the network device, wherein the information is to be used by the terminal device for at least one of following associated with a single CSI report configuration: channel state information (CSI) measurement, or CSI reporting. At block 620, the terminal device 120 performs, based on the information, one or more measurements associated with at least one spatial setting of the at least two spatial settings. At block 630, the terminal device 130 transmits, based on the information, to the network device, at least one CSI report related to the one or more measurements.

In some embodiments, the method 600 further comprises determining the at least one spatial setting based on the information. In some embodiments, the method 600 further comprises determining an order of the at least one spatial setting based on the information. In some embodiments, the information comprises at least one rule related to the at least two spatial settings, the method 600 further comprises determining an order of the at least one spatial setting based on the at least one rule. In some embodiments, the information comprises an order of the at least one spatial setting. In some embodiments, the method 600 comprises performing at least one of the following based on based on the order of at least one spatial setting: the one or more measurements, or a transmission of the at least one CSI report.

In some embodiments, the at least one spatial setting comprises a plurality of ordered spatial settings; a spatial setting among the plurality of ordered spatial settings, which is to be applicable or active first, is applicable or active after receiving the information for triggering the CSI reporting. In some embodiments, the plurality of ordered spatial settings comprises a first spatial setting and a second spatial setting adjacent to each other, the second spatial setting is to be applicable or active: immediately after the CSI report corresponding to the first spatial setting; after the CSI report corresponding to the first spatial setting by a period of time; before a first CSI-reference signal (RS) resource, among CSI-RS resources for spatial settings other than the spatial setting to be applicable or active first, occurs; when the first CSI-reference signal (RS) resource, among CSI-RS resources for spatial settings other than the spatial setting to be applicable or active first, occurs; or within a time period or based on a time offset indicated to the terminal device.

In some embodiments, the at least one spatial setting is repeated a number of times based on a periodicity of CSI reporting or based on a periodicity of CSI-RS resource or transmission. In some embodiments, a sequence including the at least one spatial setting is repeated a number of times sequence by sequence, or one or more spatial settings of the at least one spatial setting is sequentially repeated a number of times in the sequence.

In some embodiments, the at least one spatial setting comprises or corresponds to at least one of the following: at least one set of antenna ports; at least one sub-set of the set of antenna ports; at least one spatial configuration or codebook configuration; information indicative of a set of active transceiver units; information indicative of a subset of the set of active transceiver units; information indicative of a set of muted transceiver units; information indicative of a subset of the set of muted transceiver units; at least one energy level; at least one energy saving level; at least one power offset; at least one frequency related configuration; at least one CSI-reference signal (RS) resource for at least one channel measurement; at least one CSI-RS resource for at least one interference measurement; at least one spatial pattern; at least one antenna pattern; or at least one resource setting.

In some embodiments, the set of at least two spatial settings are configured by the network device to correspond to a plurality of sequences; and the method 600 further comprises selecting, based on the information, a sequence corresponding to the at least one spatial setting from the plurality of sequences. In some embodiments, for a spatial setting of the at least one spatial setting, the method 600 comprises performing at least of the following: selecting one or more spatial settings of the at least one spatial setting; performing one or more measurements for the selected one or more spatial settings; or reporting, along with the selected one or more spatial settings, the one or more measurements for the selected one or more spatial settings.

In some embodiments, the information is indicated by at least one of the following: downlink control information (DCI), medium access control control element (MAC CE), or a RRC message. In some embodiments, the information further indicates a time duration during which a measurement for a spatial setting of the at least one spatial setting is performed. In some embodiments, the spatial setting is replaced by or corresponds to a report sub-configuration or a spatial pattern. In some embodiments, the information comprises at least one of the following: a bitmap, a bit-string, or a codepoint.

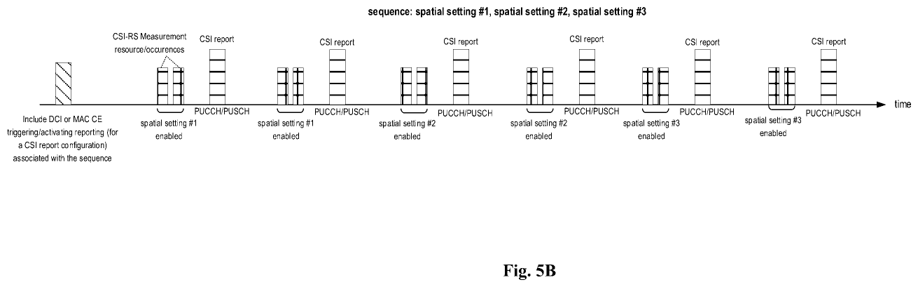

FIG. 7 illustrates a flowchart of an example method 700 implemented at a network device in accordance with some other embodiments of the present disclosure. For the purpose of discussion, the method 700 will be described from the perspective of the network device 110 with reference to FIG. 1A.

At block 710, the network device 110 transmit, to a terminal device 120, information indicative of at least two spatial settings configured at the network device, wherein the information is to be used by the terminal device for at least one of following associated with a single CSI report configuration: channel state information (CSI) measurement, or CSI reporting. At block 720, the network device 110 receives, from the terminal device 120, at least one CSI report related to one or more measurements, wherein the one or more measurements are associated with at least one spatial setting of the at least two spatial settings and performed based on the information.

In some embodiments, the at least one spatial setting is determined by the terminal device based on the information. In some embodiments, an order of the at least one spatial setting is determined by the terminal device based on the information. In some embodiments, the information comprises at least one rule related to the at least two spatial settings and an order of the at least one spatial setting is determined by the terminal device based on the at least one rule. In some embodiments, the information comprises an order of the at least one spatial setting. In some embodiments, at least one of the following is performed by the terminal device based on the order of at least one spatial setting: the one or more measurements, or a transmission of the at least one CSI report.

In some embodiments, the at least one spatial setting comprises or corresponds to at least one of the following: at least one set of antenna ports; at least one sub-set of the set of antenna ports; at least one spatial configuration or codebook configuration; information indicative of a set of active transceiver units; information indicative of a subset of the set of active transceiver units; information indicative of a set of muted transceiver units; information indicative of a subset of the set of muted transceiver units; at least one energy level; at least one energy saving level; at least one power offset; at least one frequency related configuration; at least one CSI-reference signal (RS) resource for at least one channel measurement; at least one CSI-RS resource for at least one interference measurement; at least one spatial pattern; at least one antenna pattern; or at least one resource setting.

In some embodiments, the information is indicated by at least one of the following: downlink control information (DCI), medium access control control element (MAC CE), or a RRC message. In some embodiments, the information further indicates a time duration during which a measurement for a spatial setting of the at least one spatial setting is performed. In some embodiments, the spatial setting is replaced by or corresponds to a report sub-configuration or a spatial pattern. In some embodiments, the information comprises at least one of the following: a bitmap, a bit-string, or a codepoint.

In some embodiments, an apparatus (for example, the terminal device 120) capable of performing the method 600 may comprise means for performing the respective steps of the method 600. The means may be implemented in any suitable form. For example, the means may be implemented in a circuitry or software module.

In some embodiments, the apparatus comprises: means for receiving, from a network device, information indicative of at least two spatial settings configured at the network device, wherein the information is to be used by the apparatus for at least one of following associated with a single CSI report configuration: channel state information (CSI) measurement, or CSI reporting; means for performing, based on the information, one or more measurements associated with at least one spatial setting of the at least two spatial settings; and means for transmitting, based on the information, to the network device, at least one CSI report related to the one or more measurements.

In some embodiments, the apparatus further comprises means for determining the at least one spatial setting based on the information. In some embodiments, the apparatus further comprises means for determining an order of the at least one spatial setting based on the information. In some embodiments, the information comprises at least one rule related to the at least two spatial settings, and the apparatus further comprises means for determining an order of the at least one spatial setting based on the at least one rule.

In some embodiments, the apparatus further comprises means for performing at least one of the following based on based on the order of at least one spatial setting: the one or more measurements, or a transmission of the at least one CSI report. In some embodiments, the apparatus further comprises means for selecting based on the information, a sequence corresponding to the at least one spatial setting from the plurality of sequences. In some embodiments, the apparatus further comprises at least one of the following: means for selecting one or more spatial settings of the at least one spatial setting; means for performing one or more measurements for the selected one or more spatial settings; or means for reporting, along with the selected one or more spatial settings, the one or more measurements for the selected one or more spatial settings.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some embodiments, an apparatus (for example, the network device 110) capable of performing the method 700 may comprise means for performing the respective steps of the method 700. The means may be implemented in any suitable form. For example, the means may be implemented in a circuitry or software module.

In some embodiments, the apparatus comprises: means for transmitting, to a terminal device, information indicative of at least two spatial settings configured at the apparatus, wherein the information is to be used by the terminal device for at least one of following associated with a single CSI report configuration: channel state information (CSI) measurement, or CSI reporting associated with a single CSI report configuration; and means for receiving, from the terminal device, at least one CSI report related to one or more measurements, wherein the one or more measurements are associated with at least one spatial setting of the at least two spatial settings and performed based on the information.

The apparatus further comprises means for indicating the information by at least one of the following: downlink control information (DCI), medium access control control element (MAC CE), or a RRC message.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

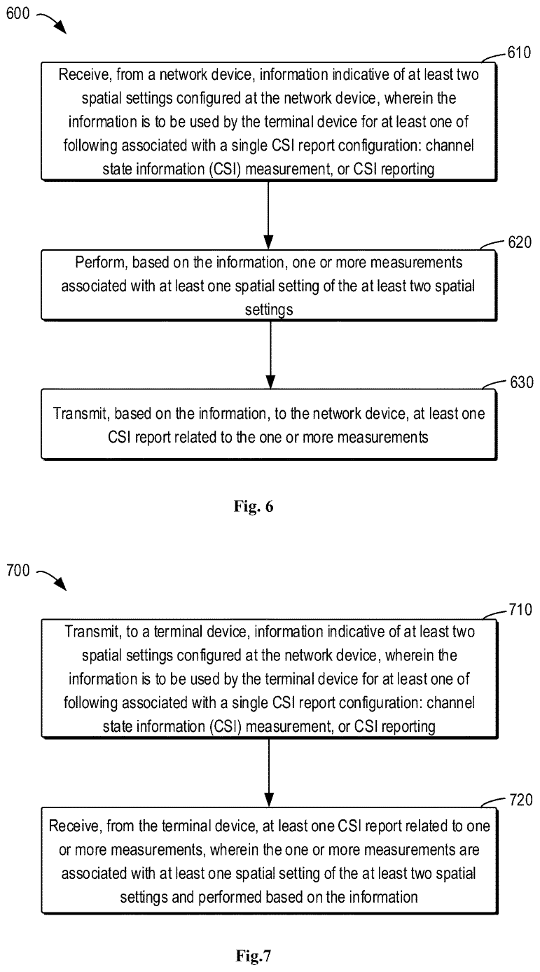

FIG. 8 is a simplified block diagram of a device 800 that is suitable for implementing embodiments of the present disclosure. The device 800 may be provided to implement the communication device, for example the terminal device 120 and the network device 110 as shown in FIG. 1A. As shown, the device 800 includes one or more processors 810, one or more memories 820 coupled to the processor 810, and one or more communication modules 840 coupled to the processor 810.

The communication module 840 is for bidirectional communications. The communication module 840 has at least one antenna to facilitate communication. The communication interface may represent any interface that is necessary for communication with other network devices.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a read only memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that may not last in the power-down duration.

A computer program 830 includes computer executable instructions that are executed by the associated processor 810. The program 830 may be stored in the ROM 824. The processor 810 may perform any suitable actions and processing by loading the program 830 into the RAM 822.

The embodiments of the present disclosure may be implemented by means of the program so that the device 800 may perform any process of the disclosure as discussed with reference to FIG. 6 and FIG. 7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like.

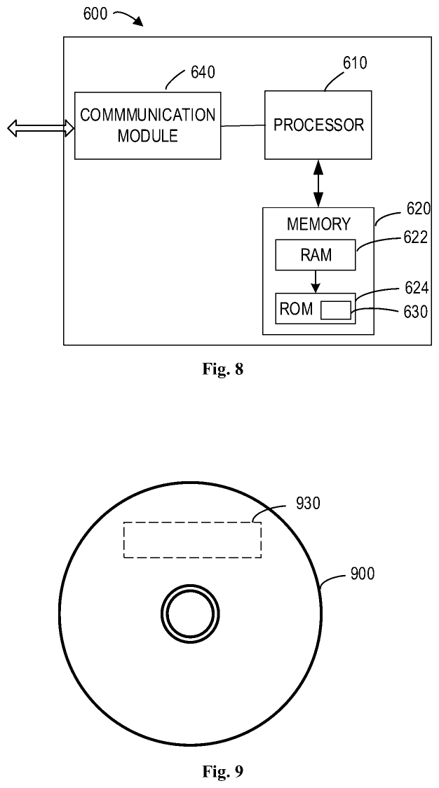

FIG. 9 illustrates an example of the computer readable medium 900 in form of CD or DVD in accordance with some embodiments of the present disclosure. The computer readable medium has the program 930 stored thereon. It is noted that although the computer-readable medium 900 is depicted in form of CD or DVD, the computer-readable medium 900 may be in any other form suitable for carry or hold the program 830.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 as described above with reference to FIG. 6 to FIG. 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that may be described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above may be disclosed as example forms of implementing the claims.

1-34. (canceled)

35. A terminal device comprising:
at least one processor; and
at least one memory storing instructions that, when executed by the at least one processor, cause the terminal device at least to:
receive, from a network device, information indicative of at least two spatial settings configured at the network device, wherein the information is to be used by the terminal device for at least one of following associated with a single channel state information (CSI) report configuration: CSI measurement, or CSI reporting;
perform, based on the information, one or more measurements associated with at least one spatial setting of the at least two spatial settings; and
transmit, based on the information, to the network device, at least one CSI report related to the one or more measurements.

36. The terminal device of claim 35, wherein the terminal device is caused to:
determine the at least one spatial setting based on the information.

37. The terminal device of claim 35, wherein the terminal device is caused to:
determine an order of the at least one spatial setting based on the information.

38. The terminal device of claim 37, wherein the terminal device is caused to:
perform at least one of the following based on the order of at least one spatial setting: the one or more measurements, or a transmission of the at least one CSI report.

39. The terminal device of claim 37, wherein:
the at least one spatial setting comprises a plurality of ordered spatial settings;
a spatial setting among the plurality of ordered spatial settings, which is to be applicable or active first, is applicable or active after receiving the information for triggering the CSI reporting.

40. The terminal device of claim 39, wherein
the plurality of ordered spatial settings comprises a first spatial setting and a second spatial setting adjacent to each other,
the second spatial setting is to be applicable or active:
immediately after the CSI report corresponding to the first spatial setting;
after the CSI report corresponding to the first spatial setting by a period of time;
before a first CSI-reference signal (CSI-RS) resource, among CSI-RS resources for spatial settings other than the spatial setting to be applicable or active first, occurs;
when the first CSI-RS resource, among CSI-RS resources for spatial settings other than the spatial setting to be applicable or active first, occurs; or
within a time period or based on a time offset indicated to the terminal device.

41. The terminal device of claim 35, wherein the information comprises at least one rule related to the at least two spatial settings,
and wherein the terminal device is caused to:
determine an order of the at least one spatial setting based on the at least one rule.

42. The terminal device of claim 35, wherein the information comprises an order of the at least one spatial setting.

43. The terminal device of claim 35, wherein:
the at least one spatial setting is repeated a number of times based on a periodicity of CSI reporting or based on a periodicity of CSI-RS resource or transmission.

44. The terminal device of claim 35, wherein a sequence comprising the at least one spatial setting is repeated a number of times sequence by sequence, or
one or more spatial settings of the at least one spatial setting is sequentially repeated a number of times in the sequence.

45. The terminal device of claim 35, wherein the at least one spatial setting comprises or corresponds to at least one of the following:
at least one set of antenna ports;
at least one sub-set of the set of antenna ports;
at least one spatial configuration or codebook configuration;
information indicative of a set of active transceiver units;
information indicative of a subset of the set of active transceiver units;
information indicative of a set of muted transceiver units;
information indicative of a subset of the set of muted transceiver units;
at least one energy level;
at least one energy saving level;
at least one power offset;
at least one frequency related configuration;
at least one CSI-RS resource for at least one channel measurement;
at least one CSI-RS resource for at least one interference measurement;
at least one spatial pattern;
at least one antenna pattern; or at least one resource setting.

46. The terminal device of claim 35, wherein:
the set of at least two spatial settings are configured by the network device to correspond to a plurality of sequences; and
the terminal device is caused to:
select, based on the information, a sequence corresponding to the at least one spatial setting from the plurality of sequences.

47. The terminal device of claim 35, wherein for a spatial setting of the at least one spatial setting, the terminal device is further caused to at least:
select one or more spatial settings of the at least one spatial setting;
perform one or more measurements for the selected one or more spatial settings; or
report, along with the selected one or more spatial settings, the one or more measurements for the selected one or more spatial settings.

48. The terminal device of claim 35, wherein the information is indicated by at least one of the following: downlink control information, medium access control control element, or a Radio Resource Control message.

49. The terminal device of claim 35, wherein the information further indicates a time duration during which a measurement for a spatial setting of the at least one spatial setting is performed.

50. The terminal device of claim 35, wherein the spatial setting is replaced by or corresponds to a report sub-configuration or a spatial pattern.

51. The terminal device of claim 35, wherein the information comprises at least one of the following: a bitmap, a bit-string, or a codepoint.

52. A network device, comprising:
at least one processor; and
at least one memory storing instructions that, when executed by the at least one processor, cause the network device at least to:
transmit, to a terminal device, information indicative of at least two spatial settings configured at the network device, wherein the information is to be used by the terminal device for at least one of following associated with a single channel state information (CSI) report configuration: CSI measurement, or CSI reporting; and
receive, from the terminal device, at least one CSI report related to one or more measurements, wherein the one or more measurements are associated with at least one spatial setting of the at least two spatial settings and performed based on the information.

53. The network device of claim 52, wherein the information comprises at least one rule related to the at least two spatial settings and wherein an order of the at least one spatial setting is determined by the terminal device based on the at least one rule.

54. A method comprising, by a terminal device:
receiving, from a network device, information indicative of at least two spatial settings configured at the network device, wherein the information is to be used by the terminal device for at least one of following associated with a single channel state information (CSI) report configuration: CSI measurement, or CSI reporting;
performing, based on the information, one or more measurements associated with at least one spatial setting of the at least two spatial settings; and
transmitting, based on the information, to the network device, at least one CSI report related to the one or more measurements.
